(19) United States
(12) Patent Application Publication
(10) Pub. No.: US 2006/0116879 A1
(43) Pub. Date: Jun. 1, 2006

(54) Context enhancement for text readers

(75) Inventors: Ruthie D. Lyle, Durham, NC (US); Fonda Daniels, Cary, NC (US)

Correspondence Address: Steven M. Greenberg, Esquire;Christopher & Weisberg,P.A., Suite 2040, 200 East Las Olas Boulevard, Fort Lauderdale, FL, 33301, US

(73) Assignee: International Business Machines Corporation, Armonk, NY (US)

(21) Appl. No.: 10/998,498

(22) Filed: Nov. 29, 2004

(51) Int. Cl. G10L 13/08

(52) U.S. Cl. 704/260

(57) ABSTRACT

A method, system and apparatus for enhancing the audible presentation of addressing information disposed in content processed in a text reader. In an aspect of the present invention, a method for enhancing the audible presentation of addressing information disposed in content processed in a text reader can include translating the addressing information into text related to underlying content referenced by the addressing information, and audibly reading back the translated text in lieu of the addressing information.

### BACKGROUND OF THE INVENTION

1. Statement of the Technical Field

The present invention relates to software accessibility and more particularly to text reading addressing information disposed in content.

2. Description of the Related Art

For more than ten years, computer scientists and engineers have addressed the accessibility of the computer program user interface—particularly for the benefit of those end users unable to interact with a computer program utilizing conventional means such as a mouse or keyboard. Presently, several assistive technologies have been widely distributed, usually in concert with the distribution of an operating system, to provide one or more alternative user interface mechanisms for the purpose of enhanced accessibility. Examples of assistive technologies include an audio user interface such as a screen reader otherwise referred to a “text reader”.

Text readers generally “read aloud” what is presented on a computer screen. Consequently, a text reader can be critical for individuals with learning disabilities since the operation of the text reader allows students to hear words on the screen. Text readers become invaluable when used in conjunction with other technologies such as word prediction, word processing, and spell checking. While text readers originally had been designed for the visually impaired, more sophisticated and affordable text readers have been marketed to a larger population, including users with or without learning disabilities. One new and important market for text readers includes the personal applications market which can encompass personal productivity applications and collaborative applications, such as electronic mail clients and instant messengers.

Although text readers are appropriate for phrases, words and short text strings, text readers have not proven helpful when processing addressing information containing complex characters and strings. Specifically, addressing information such as the venerable uniform resource locator (URL) can include not only indicators of protocol and domain, but also port data, file system structure, embedded commands and command parameters. For a text reader to process addressing information in the same manner as the text reader processes normal text can result in a long, complex and unintelligible reading of data which can be meaningless to the listener.

To compound matters, many instances of addressing information bear no apparent relationship to the content associated with the addressing information. In particular, in many cases, an intermediary can be used to distribute content, such as edge server farms and content distribution warehouses to name a few. In those circumstances, the addressing information mostly can relate to the third-party source of the content rather than the original source of the content or the content itself. Similarly, where an internal search engine or dynamic content rendering logic is involved, the bulk of addressing information for the content can bear more of a relationship to the dynamic process and less of a relationship to the content itself.

### SUMMARY OF THE INVENTION

The present invention addresses the deficiencies of the art in respect to processing addressing information in a text reader and provides a novel and non-obvious method, system and apparatus for enhancing the audible presentation of addressing information disposed in content processed in a text reader. In an aspect of the present invention, a method for enhancing the audible presentation of addressing information disposed in content processed in a text reader can include translating the addressing information into text related to underlying content referenced by the addressing information, and audibly reading back the translated text in lieu of the addressing information.

The translating step can include mapping the addressing information to text found in the underlying content. For instance, the mapping step can include mapping the addressing information to text found in attribute tags in the underlying content like image tags. The translating step further can include mapping the addressing information to manually specified text. Finally, the translating step yet further can include parsing the addressing information into constituent components, and generating an articulation as translated text using portions of the constituent components and terms which specify a role for the constituent components. These constituent components can include protocol parameters such as hypertext transport protocol (HTTP) parameters.

A text reading system configured to contextually enhance the articulation of addressing information in content by a text reader can include a data store of contextual information. The contextual information can include one or more mappings, each mapping having a reference to at least a portion of addressing information and corresponding contextual text. In this regard, the addressing information can include uniform resource locators. The system yet further can include address translation logic configured for communicative coupling to the data store and to a text reader. The contextual text can be text obtained from underlying content specified by the addressing information, or text obtained from fragments in the addressing information. The contextual text also can be manually specified text.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a system configured for the contextual enhancement of a text reader; and,

FIG. 2 is a flow chart illustrating a process for contextually enhancing the text reading of addressing information in the system of FIG. 1.

### DETAILED DESCRIPTION OF THE PREFERRED EMBODIMENTS

The present invention is a method, system and apparatus for the enhancement of a text reader when processing addressing information disposed in readable content. In accordance with the present invention, addressing information associated with underlying content can be compared to contextual data mapped to the addressing information. Subsequently, the contextual data can be used to formulate an articulation which can be read by the text reader rather than the textual content of the addressing information. In this way, the text reader can read a more contextual accurate rendition of the underlying content associated with the addressing information than the addressing information itself.

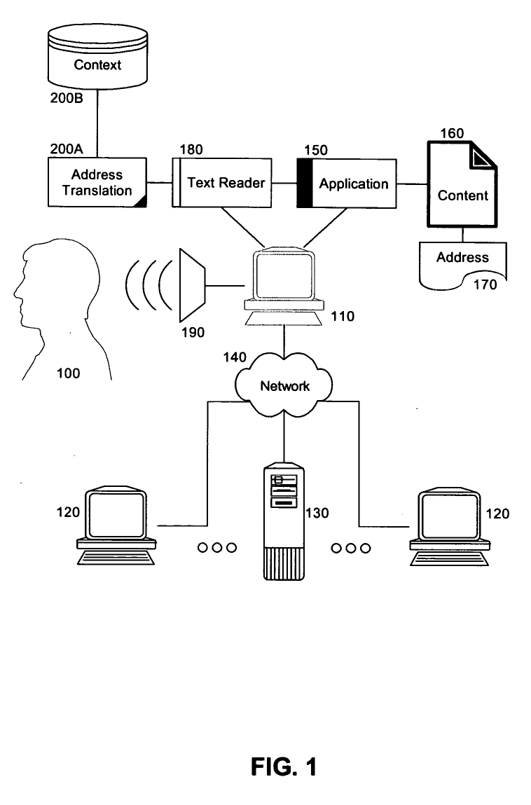

In more particular illustration, FIG. 1 is a schematic illustration of a system configured for the contextual enhancement of a text reader. The system can include a host computing platform 110 configured to be communicatively linked to one or more client computing platforms 120, and at least one content source server 130 disposed about a computer communications network 140 a portion of which can include the global computer communications network known as the Internet. The host computing platform 110 can be further configured to support the operation of one or more applications 150, which applications 150 can include by way of example, personal productivity applications and collaborative applications.

At least one of the applications 150 can include operative code for rendering content 160, either visually, audibly, tactically, or through any combination thereof. To facilitate an audible rendering of the content 160, a text reader 180 further can operate in cooperation with the application 150. Specifically, the text reader 180 can process text within the content 160 and can provide voice playback of the text for the benefit of a listener 100 through suitable transducer 190 such as audio speakers or headphones.

Importantly, addressing information 170 can be disposed within the content 160. The addressing information 170 can include textual data which can be processed by the application 150 to locate and retrieve content over the computer communications network 140. For example, the addressing information 170 can be a URL which can include a protocol portion, a domain portion and a content identifier. As it will be well understood by the skilled practitioner, the URL further can include port data, directory structure information, one or more embedded commands and possibly command parameters. To enhance the handling of the addressing information by the text reader 180, address translation logic 200A and corresponding context 200B can be operatively coupled to the text reader 180.

The address translation logic 200A can be programmed to translate the addressing information 170 utilizing the context 200B to render an articulation which better describes the underlying content referred to by the addressing information 170. For example, the context 200B can include contextually pertinent text mapped to one or more elements of the addressing information 170, such as the domain, the parameters of a command disposed in the addressing information 170, or the name of a file referenced by the addressing information 170. The context 200B alternatively can include manually mapped text describing the underlying content associated with the addressing information 170.

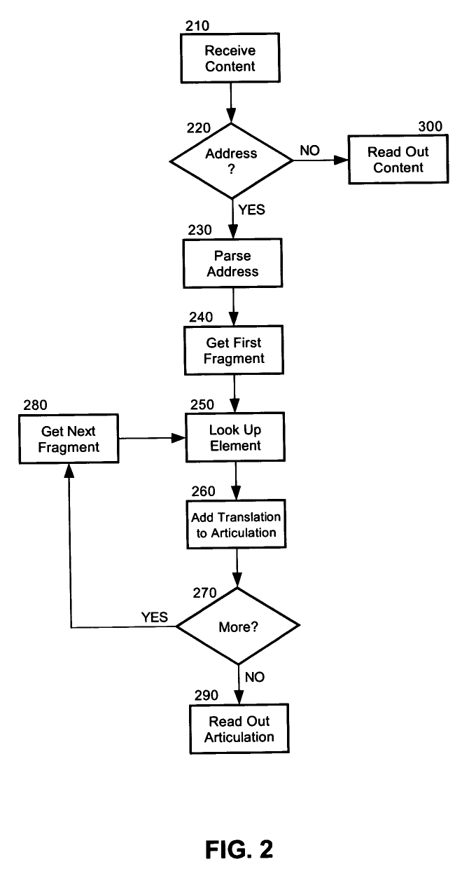

In more particular illustration, FIG. 2 is a flow chart illustrating a process for contextually enhancing the text reading of addressing information in the system of FIG. 1. Beginning in block 210, content can be received and processed in the text reader. In decision block 220, it can be determined whether addressing information is to be processed by the text reader due to the fact that the text forming the addressing information cannot be processed by the text reader as is. If not, in block 300 the content can be processed as is by the text reader. Otherwise, the text reading of the addressing information must be enhanced and the process can proceed through block 230.

In block 230, the addressing information can be parsed into one or more fragments. In block 240, a first fragment can be retrieved and in block 250 the fragment can be mapped to a context definition. In this regard, the context definition can include text similar to that found in the fragment, text obtained from the underlying content referred to in the addressing information, or manually specified text.

For example, to the extent the addressing information is a URL, the URL string can be interpreted using HTTP. HTTP parameters allow for additional context stings such as: hostname, port, absolute path and queries (“//host” [“:” port] [abs_path [“?” query]]) to be ascertained from the URL string. Thus, considering the URL string, “http://www.domain.com/search?h1=en&ie=UTF−8&oe=UTF−8&q=Keyword1+and+>Keyword2”, a translation can be produced such as, “This URL is for a domain.com query/search of the logical AND-ing of the keywords KEYWORD1 and KEYWORD2”.

As another example, as many users insert addressing information in a document which results from browsing information from a particular network location, context information can be captured from data residing at the particular network location. For instance, image tags in the underlying content referred to by the addressing information can be captured during the browsing session and associated with the addressing information for the underlying content. Subsequently, text of the image tags can be utilized by the text reader in articulating the addressing information.

In any case, referring again to FIG. 2, in block 260 the mapped context for the fragment can be added to an articulation. In block 270, if more fragments remain to be processed in the addressing information, in block 280 the next fragment can be retrieved. Subsequently, in block 250 the fragment again can be mapped to a translation and the translation can be added to the articulation. Finally, when no more fragments remain to be processed in the addressing information, in block 290 the articulation can be read out by the text reader as a contextually relevant articulation of the addressing information.

The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

We claim:

1. A method for enhancing the audible presentation of addressing information disposed in content processed in a text reader, the method comprising the steps of:
translating the addressing information into text related to underlying content referenced by said addressing information; and,
audibly reading back said translated text in lieu of said addressing information.

2. The method of claim 1, wherein said translating step comprises the step of mapping the addressing information to text found in said underlying content.

3. The method of claim 1, wherein said translating step comprises the step of mapping the addressing information to manually specified text.

4. The method of claim 1, wherein said translating step comprises the steps of:
parsing the addressing information into constituent components; and,
generating an articulation as translated text using portions of said constituent components and terms which specify a role for said constituent components.

5. The method of claim 4, wherein said constituent components comprise protocol parameters.

6. The method of claim 2, wherein said mapping step comprises the step of mapping the addressing information to text found in attribute tags in said underlying content.

7. The method of claim 2, wherein said mapping step comprises the step of mapping the addressing information to text found in said underlying content.

8. A text reading system configured to contextually enhance the articulation of addressing information in content by a text reader, the system comprising:
a data store of contextual information, said contextual information comprising a plurality of mappings, each mapping comprising a reference to at least a portion of addressing information and corresponding contextual text; and,
address translation logic configured for communicative coupling to said data store and to a text reader.

9. The text reading system of claim 8, wherein said addressing information comprises uniform resource locators.

10. The text reading system of claim 8, wherein said corresponding contextual text comprises text obtained from underlying content specified by said addressing information.

11. The text reading system of claim 8, wherein said corresponding contextual text comprises text obtained from fragments in said addressing information.

12. The text reading system of claim 8, wherein said corresponding contextual text comprises manually specified text.

13. A machine readable storage having stored thereon a computer program for enhancing the audible presentation of addressing information disposed in content processed in a text reader, the computer program comprising a routine set of instructions which when executed by a machine causes the machine to perform the steps of:
translating the addressing information into text related to underlying content referenced by said addressing information; and,
audibly reading back said translated text in lieu of said addressing information.

14. The machine readable storage of claim 13, wherein said translating step comprises the step of mapping the addressing information to text found in said underlying content.

15. The machine readable storage of claim 13, wherein said translating step comprises the step of mapping the addressing information to manually specified text.

16. The machine readable storage of claim 13, wherein said translating step comprises the steps of:
parsing the addressing information into constituent components; and,
generating an articulation as translated text using portions of said constituent components and terms which specify a role for said constituent components.

17. The machine readable storage of claim 16, wherein said constituent components comprise protocol parameters.

18. The machine readable storage of claim 14, wherein said mapping step comprises the step of mapping the addressing information to text found in attribute tags in said underlying content.

19. The machine readable storage of claim 14, wherein said mapping step comprises the step of mapping the addressing information to text found in said underlying content.
